(19) United States
(12) Patent Application Publication
(10) Pub. No.: US 2003/0190008 A1
(43) Pub. Date: Oct. 9, 2003

(54) Method and device for controlling pressure waves in targets of spallation neutron sources

(76) Inventor: G?uuml;nter Hansen, (US)

Correspondence Address: DOWELL & DOWELL PC, SUITE 309, 1215 JEFFERSON DAVIS HIGHWAY, ARLINGTON, VA, 22202

(21) Appl. No.: 10/275,431

(22) PCT Filed: Apr. 26, 2001
(86) PCT No.: PCT/DE01/01599

(30) Foreign Application Priority Data
May 6, 2000 (DE) 100 22 211.0

(51) Int. Cl. H05H 3/06; G21G 1/10

(52) U.S. Cl. 376/194

(57) ABSTRACT

The invention relates to a method for producing neutrons with the aid of a spallation effect. The method includes the diversion of a partial cooling stream out of the main cooling stream and an acceleration of the partial cooling stream in such a manner that vapor bubbles are formed in the vacuum region produced by the acceleration, and after introduction into the main cooling stream, said vapor bubbles act upon generated pressure waves in an attenuating manner during the impingement of a proton beam.

The present invention relates to a method for producing neutrons with aid of a spallation effect according to the preamble of claim 1.

In systems for producing neutrons by the so-called spallation effect, high-energy protons are shot at a target consisting of heavy atomic nuclei. The nuclei are thereby excited to such an extent that they release a great number of neutrons (about 20 neutrons per proton) in a type of evaporation process.

Liquid metals, such as for example lead and bismuth or their eutectic and mercury, are use as target material in high-performance systems. Elements having a high mass number are especially suitable due to the great number of neutrons in the nucleus. Furthermore, due to their good heat transfer properties, the liquid metals also enable a safe discharge of the heat produced in the spallation process.

The targets of high-performance spallation neutron sources are found in a thin-walled steel container which is flowed through with the liquid target material (the liquid metal). A stream of the liquid target material is produced inside the container in such a way that, in particular the wall area through which the proton beam penetrates into the container, is effectively cooled.

To produce high short-term neutron flows, the spallation neutron sources are operated in a pulsed manner. The proton beam, which is to release neutrons, periodically impinges the target material with a frequency of some 10 hertz and, per period, only for a very short time of about 1 μs. Within this very short pulse duration, a very high energy is deposited in the liquid target material by the nuclear reactions, so that a very strong pressure wave, with pressure values of 1000 bar and more, are formed in it. These strong pressure waves in the liquid target material result in stresses in the structure of the target container which clearly exceed the permissible material values. Thus, without further measures, the target container will already be destroyed after a few pulses.

It is known from the prior art that, to control these pressure waves, gas bubbles be introduced into the liquid metal system to increase the compressibility. A disadvantage of this feature of the prior art is that, to carry it out, equipment is required to introduce the gas bubbles into the liquid target material or to remove it. However, the decisive disadvantage is that it is extremely difficult to produce a uniform gas bubble distribution in the complex flow field of the liquid target material and to also keep the distribution constant over a longer period of time.

Thus, the object of the present invention is to create a method for producing neutrons with aid of a spallation effect with which-the pressure waves can be controlled without the disadvantages associated with a gas bubble input.

According to the invention, the object is solved by the characterizing features of claim 1.

With the method of the invention according to claim 1, it is possible to produce vapor bubbles in the cooling stream of the liquid target material and in the area in which the pressure waves are generated, said vapor bubbles attenuating the pressure wave generated during the impingement of a proton beam.

The vapor bubbles are unstable such that they collapse in the pressure wave area during impingement of a pressure wave. They contribute to the attenuation due to collapsing.

However, the vapor bubbles are also stable such that they increase the compressibility of the cooling stream of the liquid target material and, as a result, e.g. in the peripheral area of the pressure waves, contribute to the attenuation of the pressure waves.

Degassing processes in the partial cooling stream are produced with the production of a vacuum region due to acceleration of the partial cooling stream in such a way that gas bubbles are produced which, in turn, contribute to the attenuation of the pressure waves.

Furthermore, by accelerating the partial cooling stream, high shearing forces are produced in the liquid target material which shatter gas bubbles produced by degassing and contribute to a more uniform distribution thereof in the partial cooling stream. This also improves the attenuation of the pressure waves.

However, the vapor bubbles are unstable in such a way that they collapse in a time interval between two successive proton beam pulses when they are transported out of the vacuum region by the cooling stream. As a result, no device is required for removing the vapor bubbles produced.

The method proceeds as follows:

A small portion of the cooling stream of the liquid target material is diverted and conveyed via one or more pipes within the target container in the vicinity of the area in which the pressures waves are generated by the impinging proton beam. Just before this partial cooling stream of the liquid target material is combined again with the so-called main cooling stream inside the target container, the partial cooling stream is greatly accelerated in appropriate devices, e.g. jets, diaphragms or the like, in such a way that cavitation effects are produced in a vacuum region formed by the acceleration. Within the scope of such cavitation effects, vapor bubbles, which are usually uniformly distributed, form within the liquid target material. When a proton beam now produces a pressure wave in the liquid target material and it impinges the vacuum region, the vapor bubbles present in it collapse. This leads to a short-term local reduction of the volume requirement of the liquid vapor bubble mixture. Due to the fact that no thermodynamic balance can set in in this relatively short time, the pressure wave is attenuated before it reaches the structures of the target container. Vapor bubbles of this type which do not collapse during impingement of the pressure wave increase the compressibility of the cooling stream and, as a result, also contribute to the attenuation of the pressure wave.

In the time interval between two successive proton beam pulses, no pressure waves are produced. In this time interval, the vapor bubbles collapse again when they are again transported out of the vacuum region through the cooling stream of the liquid target material. For this reason, no device is required for removing and introducing the vapor bubbles.

Furthermore, degassing processes in the cooling stream of the liquid target material are produced by the formation of a vacuum region by accelerating the partial coolant stream. Gases dissolved in the cooling stream are thereby released in the form of gas bubbles. These released gas bubbles also then contribute significantly to the attenuation of the pressure waves.

The described device for producing the vacuum region in the target container also results in a further positive effect for gas bubbles which are already in the cooling stream of the liquid target material, e.g. by entrainment effects at free surfaces of the cooling circuit or from the spallation processes. In fact, high shearing forces which shatter these gas bubbles and thus lead to a uniform distribution of the gas bubbles are produced within the vacuum region by acceleration of the coolant. The attenuation of the pressure waves is also positively affected by this.

1. Method for producing neutrons with aid of a spallation effect, comprising the following steps:
providing a liquid target material in a container;
producing a main cooling stream of the liquid target material;
aligning the proton beam to the liquid target material, pressure waves being formed due to the impingement of the proton beam in the liquid target material,
characterized by the further steps:
diverting a partial cooling stream from the main cooling stream of the liquid target material;
accelerating the partial cooling stream such that vapor bubbles are formed in a vacuum region produced thereby;
introducing the accelerated partial cooling stream with the vapor bubbles in the vicinity of the area of the main cooling stream in which the pressure waves are generated in the liquid target material.

2. Method according to claim 1, characterized therein that the pressure waves are attenuated by collapse of the vapor bubbles in the pressure wave region.

3. Method according to claim 1 or claim 2, characterized therein that the pressure waves are attenuated by an increase in the compressibility of the cooling stream by the vapor bubbles.

4. Method according to any of the claims 1 to 3, characterized therein that degassing processes are produced in the partial cooling stream with the formation of a vacuum region by acceleration of the partial cooling stream, the pressure waves being attenuated by the gas bubbles produced within the scope of the degassing processes.

5. Method according to any of the claims 1 to 4, characterized therein that high shearing forces are produced due to the acceleration of the partial cooling stream, said shearing forces shattering the gas bubbles and distributing them in the partial cooling stream, as a result of which the pressure waves are attenuated.

6. Method according to any of the claims 1 to 5, characterized therein that the vapor bubbles are unstable such that they collapse in a time interval between two successive proton beam pulses when they are transported out of the vacuum region through the cooling stream.
